(19) United States
(12) Patent Application Publication
(10) Pub. No.: US 2007/0020478 A1
(43) Pub. Date: Jan. 25, 2007

(54) Hot-dip galvanized steel sheet having transformation induced plasticity, excellent in formability, adhesive property of plating/formability, and manufacturing process thereof

(75) Inventors: Man-been Moon, Seoul (KR); Chirl-soo Shin, Seoul (KR); Sung-joon Kim, Changwon-shi (KR); Chang-seok Oh, Changwon-shi (KR)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Hyundai Hysco Co., Ltd.

(21) Appl. No.: 11/489,227

(22) Filed: Jul. 19, 2006

(30) Foreign Application Priority Data
Jul. 20, 2005 (KR) 2005-66054

(51) Int. Cl. B32B 15/18

(52) U.S. Cl. 428/659; 148/533

(57) ABSTRACT

The present invention relates a hot-dip galvanized steel sheet having transformation induced plasticity, mainly used in supporting or reinforcing structure of cars.

The galvanized steel sheet comprises C: 0.05 to 0.20 wt. %, Si: 0.05 to 0.35 wt. %, Mn: 1.0 to 2.5 wt. %, Al: 0.01 to 1.5 wt. %, P: 0.02 wt % or less, Co: 0.3 to 0.8 wt. %, remained are Fe and inevitable impurities, satisfying relations between the above Si and Al, as 0.6≦Si+0.78 Al(%)≦1.2. This galvanized steel sheet is produced by steps of hot rolling of the steel slab comprising the above chemical compositions, and coiling the hot-rolled steel sheet at 500 to 700° C., recrystallization annealing treatment at the temperature range of 740° C. to 880° C. for 1-5 minutes and coiling, and cooling to 300° C. to 580° C. with cooling rate of 2 to 100° C./sec. and preserving at temperature range of 300 to 580° C. for not more than 10 min. and, zinc plating. If necessary, alloying heat treating for not more than two (2) minutes, may be applied, for controlling volume ratio of 2-20% of retained austenite. Then, the above treated steel sheets are finally cooled, and finished. At that result, a hot-dip galvanized steel sheet having transformation induced plasticity characterized more than 60 kg/mm² of T.S., and more than 28% of elongation, satisfying volume ratio of 2-20% of the retained austenite structure, can be obtained.

### TECHNICAL FIELD

The present invention relates to a hot-dip galvanized steel sheet having transformation induced plasticity, and manufacturing process thereof. And further, the steel sheet of the present invention concerns the steel sheet particularly for having more than 60 kg/mm² of tensile strength (T.S.) and more than 28% of elongation, by optimizing conditions of chemical compositions and other manufacturing process.

### BACKGROUND ART

In recent, there has been the tendency of lightening car-weight for improving mileage, and protection of natural environment. For the purpose of reducing car weight, and mileage ratio etc. many studies and experiments had been taken to reduce steel thickness by applying high-tension steel sheet in automobile use.

However, the high-tension steel sheet consisting solid solution reinforced elements such as P, Si, Mn etc., and deposition-reinforced elements such as Ti, Nb, etc. is inferior in formability, whereas their strength is high. In this reason, steel sheet having transformation induced plasticity, which satisfies high-strength and high-formability at the same time, has been developed.

When coiled steel which includes 0.07-0.4 wt. % (hereafter wt. %) carbon(C), 0.4-2.0% silicon(Si), 1.0-3.0% manganese(Mn) as the basic elements, would be treated to bainite at about 400° C., after austenite is formed, it may bring about concentration of carbon to be the form of untransformed austenite as to get the stable retained austenite in the room temperatures. This steel of retained austenite phase is usually defined as “TRIP steel”. This retained austenite phase is transformed into rigid martensite while it is worked, create the enlarged plasticity of steel material satisfying steel strength and formability at the same time.

However, when the silicon (Si) would be contained more than 0.4%, in the above said steel, it may be unproper to apply a hot-dip galvanized steel sheet mainly used in cars, because of reasons that the Si element may be spreaded and concentrated on surface of the steel sheet, forming Si-oxidized film, during continuous annealing treatment which cause lower adhesive property of zinc(Zn) plating. At the result, it makes not only easier peeling of plated film, but also makes easier unplating of the zinc on the surface of the steel sheet.

For preventing such the problems, there are known arts to add element N, for example, in the Korean Unexamined Patent Publication No. 2002-0002252, Ni for example, in the Korean Unexamined Patent Publication No. 2001-0085282, and Sn for example, in the Korean Unexamined Patent Publication No. 2003-0063484, to improve adhesive property of transformation induced plasticity. However, even in these prior arts which include specific chemical compositions for improving adhesive property, still the Si is included more than 0.4%, so that deficiency of adhesive property in the transformation induced plasticity steel sheet, can not be basically cured, as to be applied in mass production.

In the prior arts of Japanese Unexamined Patent Publication, No. 2004-333552, and No. 2004-346644, improving methods for adhesive property of plating are shown, in which Ni electroplating before the stage of hot-dip galvanizing process, on the way of high temperature annealing, brings about preventing effect of diffusion of silicon to the steel surface. However, it may result decrease of production, and not economical, when hardness is high, elongation is insufficient, and plating adhesives are much thicker, then, flaking or peeling of the plated film may easily be occurred. And that, when electroplating, besides the hot-dip galvanized plating, would be applied, two kinds of plating facilities should be prepared which results decrease of production of the plated steel sheets.

In the prior art opened as Korean Unexamined Patent Publication No. 2003-53834 in which the steel sheet having transformation induced plasticity, is recrystallization annealing heat treated in the continuous annealing furnace, and cooled, and then, again it is pickled in the hot-dip galvanized plating facilities, grinded by 0.1 -1 urn of silicon (Si) concentrated layer formed on the steel surface, using brush-roll, and thereafter, heat treated at the temperature of 460-550° C. in the heating zone, and immersed, plated in the plating bath. However, in this process, additional lines of pickling and heat-treating, plating lines and facilities, besides the continuous heating line, are also required. In addition, two kinds of manufacturing process should be taken, which are not economical.

### SUMMARY OF THE INVENTION

In view of the above circumstances, the present invention is to stably provide a hot-dip galvanized steel sheet having transformation induced plasticity, excellent in adhesive property of plating and formability by controlling silicon(Si)-content, adding aluminum (Al), cobalt (Co) with proper amount, as to obtain stable austenite structure in the room temperature, finally for the purpose of obtaining steel sheet excellent in tensile strength (T.S.) more than 60 kg/mm², elongation more than 28%, by means of optimizing alloying temperature.

It is an object of the present invention to provide a production method of steel sheet having transformation induced plasticity, with volume ratio 2-20% of the retained austenite, and T. S. more than 60 kg/mm², elongation more than 28%, after the hot-rolled process of steel slab comprising the aforementioned chemical composition, recrystallization annealing, Zn plating, cooling, etc.

The chemical compositions of the present invention, should be controlled for achieving the above objects, as follows:

| C: | 0.05-0.20% (wt. %, hereafter same) |
|---|---|
| Si: | 0.05-0.35% |
| Mn: | 1.0-2.5% |
| Al: | 0.01-1.5% |
| P: | 0.02% or less |
| Co: | 0.3-0.8% |

remained are Fe and inevitable impurities.

Wherein, Si and Al should satisfy the following relationship:
0.6≦Si+0.78Al(%)≦1.2 (1)

The process of the present invention comprises coiling at the temperatures of 500-700° C., after the hot rolling slab comprising the above chemical compositions; recrystallization annealing treatment for 1-5 min. at the temperature range of 740-880° C.; cooling at the speed of 2-100° C./sec. and then, reserving the steel sheet at the temperature range of 300-580° C. for 10 min. or less; and then galvanizing in the plating bath; and alloying heat treated for two(2) min. or less, at the temperature range of 460-600° C.; finally cooled for the purpose of obtaining Fe 5-20% in the plated layer, 2-20 vol. % of the retained austenite, T.S. more than 60 kg/mm², elongation more than 28% in the steel sheet product having transformation induced plasticity.

The present invention is described in detail as follows:

As stated the above, the present invention is to produce hot-dip galvanized steel sheet having transformation induced plasticity, by controlling Si-content 0.35% or less, by adding Al and Co with proper amount, for improving mechanical properties, such as T. S. more than 60 kg/mm², elongation more than 28%, as explained before.

Carbon(C):

Carbon (C) is the austenite stabilization element. It concentrates in the austenite structure, when it would be at the temperature area of two (2) phase co-existence and at the temperature area of bainite transformation, which brings about remaining 2-20% of the retained austenite which is stable in room temperatures, with good formability based on the transformation induced plasticity. If the C-content would be 0.05% and less, securing strength becomes difficult, because part rate of the retained austenite is low, whereas this C-content would be over 0.20%, then, welding property becomes deteriorated, so that the C-content is limited to the range of 0.05-0.20%.

Silicon(Si)

Silicon (Si) is the element to increase strength by reinforcing solid solution, suppressing precipitation of cementite, while reserving at the temperature area of 350-600° C. after annealing heat treatment. It also accelerates concentration of the austenite which induce to improving formation of retained austenite and elongation property. If Si-content would be less than 0.05wt. %, stabilization effect of austenite would be eliminated, otherwise Si-content would be in excess of 0.35 wt. %, Si-oxides are concentrated thereon, resulting deterioration of weldability and plating effect. In this reason, Si-content is limited to the range of 0.05-0.35wt. %, in the present invention.

Manganese(Mn):

(Mn) is the stabilization element of austenite, which delay decomposition of austenite to pearlite during process of cooling at temperature range of 300-580° C., after annealing. It promotes forming inclusions of the retained austenite in the fine structure of the steel. If the Mn would be added 1.0% or less, delay of decomposition of the austenite to the pearlite becomes difficult. On the other hands, if it would be over 2.5%, then, weldability will be deteriorated. Therefore, the Mn-content should be limited at the range of 1.0-2.5%.

Aluminum (Al)

Aluminum (Al) is the deoxidization element, which suppress precipitation of cementite. It also stabilize austenite as the Si. When Al-content would be less than 0.1%, austenite stabilization effect is eliminated. In case in excess of 1.5% Al, formation of Al-oxides in the molding process, results hot shortness and deterioration of elongation. Therefore, the Al-content is limited to 0.01-1.5%.

Al and the Si are the important chemical elements for securing volume ratio of retained austenite, should be controlled for satisfying the relation formula (1), as stated above. That is, 0.6≦Si+0.78A1(%)≦1.2

If the value of the Si+0.78A1(%) would be under 0.6, securing retained austenite with sufficient quantity becomes difficult, and so formability becomes largely deteriorated. If this value would be in excess of 1.2, then, adhesive property of plating on the steel surface, becomes deteriorated, caused by the film of oxides, thereon. Then, production of galvanized steel becomes almost impossible. Therefore, the proper range of the composition is limited within the range of the above formula (1)

Phosphorus (P):

Phosphorus(P) is the element to increase strength of steel by solid solution reinforcement. When it is added with element of Si, while reserving of 300-580° C., it inhibits formation of cementite, and accelerating concentration of carbon content, so that, P should be limited 0.02% or less. If this P-content would be in excess of 0.02%, secondary brittleness during working may be generated.

Cobalt (Co):

Cobalt(Co) is one of the most important element which forms austenite as element Mn. This Co is not solved in the form of the solid solution in the cementite structure as Si, and Al. This cause to suppress precipitation and to delay transformation of cementite while reserved at 300-580° C. This means that proper adding Co increases volume ratio of the retained austenite which improves formability and strength of the steel. Co is not the element to be easily oxidized, than Fe. Co suppresses formation of Si-oxides and Al-oxides etc., which hinder adhesive property. Therefore, Co is to be added more than 0.3%, for securing adhesive effect, but added not more than 0.8%, for preventing deterioration effect to elongation. Therefore, its proper adding range is limited to 0.3-0.8%, for improving adhesive property of plating, which results steel having transformation induced plasticity, excellent in strength and elongation.

Hereunder, production process is described. Slab comprising the above chemical compositions, are prepared from molten steel, and con-cast or cast steel. This slab is treated in the process of hot-rolling, cold-rolling and annealing for obtaining predetermined mechanical property. Each producing conditions are explained as follows:

Hot-Rolling Process

In the hot-rolling process, finished rolling temperature should be higher than A3 transformation temperature, for obtaining fine structure of the steel, after then, it is subject to descaling in the pickling line with high-pressure descaling device.

Coiling Process

The above said hot-rolled steel sheet is coiled in the temperature of 500-700° C., for acquiring better mechanical property after the cold-rolling and recrystallization heat treating. If this coiling temperature would be under 500° C., cold-rolling becomes difficult, for formation of bainite or martensite generated thereby. Otherwise, grain structure becomes coarse, if it would be over 700° C., which causes insufficient strength of the steel sheet.

Cold-Rolling Process

The above treated hot-coil is subject to cold-rolling, which is preferably cold-rolled by reduction rate of 30-80%. Cold-rolling transforms hot-rolled steel structure and contributes generation of transformation energy of recrystallization. This transformation effect becomes small when the reduction rate of the cold-rolling would be under 30%, whereas very large when it is over 80% which is substantially very difficult to be worked, because of higher possibility of causing cracks on the marginal portions or breakage of the steel sheet. Therefore, it is better to choose the range of 30-80% as the proper reduction rate in the above said cold-rolling.

Recrystallization Annealing and Plating

After the cold-rolling process, the cold-rolled steel sheet is recrystallization annealing treated for 1-5 min, at 740-880° C. For forming two(2) phase structure of ferrite and austenite by annealing heat treatment, Ac1 to Ac3 transformation temperature is preferable. Under 740° C., too many times are required to resolve the cementite. On the contrary, when it is over 880° C., too many volume ratio of the austenite is generated. Therefore, temperature range was preferably taken as 740-880° C., for preventing reduction of carbon concentration.

After annealing treatment, the above treated steel sheet is cooled at the temperature range of 300-580° C., with cooling rate 2-100° C./sec. If the cooling rate would be less than 2° C./sec., the austenite is transformed to pearlite as to the retained austenite becomes difficult to be secured, during the cooling procedure. If it is over 100° C./sec., deviations of the finished temperature of the cooling may largely be generated, resulting the steel to be uneven. Therefore, the cooling rate is limited within the above said range. It is possible to apply the rapid cooling rate by 100° C./sec. to the final finishing temperature, after it is slowly cooled at 5° C./sec. or less until 650-700° C.

After cooling to the temperature range of 300-580° C., it is held in the above temperature. This treatment is done for forming stable retained austenite in room temperatures, at the result of that parts of the austenite is transformed into bainite which results carbon concentration effect as the form of untransformed austenite, in room temperatures. In this case, if the above temperature would be less than 300° C., lots of austenite tend to transform martensite structure, which results deterioration of formability. Meanwhile, a lot of austenite structures may be decomposed to carbide in excess of 580° C. Therefore, the preferable temperature range is limited to 300-580° C. While, reserved at this temperature range for about 10 min. or more, over transforming of bainite and/or carbide from the austenite, formability is deteriorated. In this reason, this reserving time is limited to 10 min. and less.

Zinc-plating in the galvanized bath is taken after staying of 10 min. and less, at the temperature range of 300-580° C. Galvanizing solution for Zn plating, comprises 0.10-0.20 wt. % of Al, and the remained are Zn, and inevitable impurities. Reasons of limiting Al-content in the plating bath solution, are that Fe-Zn alloy layer which is hard and brittle, is formed in the plated film, when the Al content comprises less than 0.10 wt. %. In case of that Al content would be over 0.20 wt. %, over formation of upper dross and hard workability for alloying treatment would be resulted.

After Zn-plating, alloying heat, treatment is applied at 460-600° C., in the metal alloying furnace, for not more than two(2) minutes, for the purpose of controlling the alloying degree (Fe %) within 5-20%. of the plated layer. It is the reason why this Fe % should be 5-20%, is that weldability becomes deteriorated in case of under 5%, while, in case of over 20%, gamma phase (Fe5Zn21) having hard structure in the alloyed layer, is formed, which creates powdering state, when it is worked. Therefore, alloying temperature and heat treating time should be properly controlled within the range of 460-600° C., for not more than two(2) minutes. If the said temperature would be under 460° C., then, the alloying degree would be under 5%. If the alloying temperature would be over 600° C., this alloying degree is upwardly increased over 20%. Therefore, the temperature range is limited to 460-600° C. Alloying time is limited to two(2) min. or less for preventing deterioration of mechanical property by excessive precipitation of bainite and/or carbide. It is possible to produce zinc plated sheet without alloying heat treatment, and cool the plated sheet, for producing galvanized steel sheet thereafter.

With the above procedure, the present invention can produce alloyed, and hot-dip galvanized steel sheet having transformation induced plasticity, satisfying volume ratio of 2-20%, in the retained austenite, excellent in adhesive property, mechanical property like T.S. more than 60 kg/mm², more than 28%.

Hereinafter, the present invention is be described in detail by way of examples, but the present invention is not limited to these examples.

### EXAMPLES

Chemical compositions of the examples of the inventions, and examples of the comparative examples, are shown in Table 1. They had been hot-rolled, and finish-rolled at the temperature of 950° C., and coiled. Then, the coiled sheets were cold-rolled, hot-dip plated. In this case, hot-rolled steel sheet ( thickness:4 mm ) was rolled as cold-rolled sheet (thickness:1 mm) for the test sheets No. 1 to No. 6. In a case that hot-rolled steel sheet (thickness:2.8 mm) rolled to cold-rolled steel sheet (thickness:1.4 mm) is shown as the test No. 7 to No. 9.

After cold-rolling, annealing heat treatment is applied in the annealing furnace with various temperatures, as shown in Table 3.

They were slowly cooled to about 670° C., with cooling rate of 3° C./sec. and then, rapidly cooled to about 465° C. with cooling rate of 15° C./sec., and held at this temperature of about 465° C. for 54 sec. and then zinc plated in the plating bath in which the Al is included in amount of 0.13 wt. %. In this case, total coated zinc quantity was 60gram/m2 on inner/outer surface for both the present invention and the comparative examples. After the plating alloy heat treating was applied in the induced heating furnace on the conditions as in Table 3.

Then, the above heated test sheets were cooled, and analyzed volume ratio of utilizing XRD. Adhesive property plating was evaluated in view of the conditions shown in Table 2, observing and utilizing microscope. Mechanical properties such as T.S. and elongation were also measured using T.S. tester.

In the above tests, results are shown in Table 3. Test piece No. 1 to No. 4 which satisfy relation formula 0.6≦Si+0.78A1(%)≦1.2, shows more than 4% austenite portions on the condition of the present invention. Among these test sheet, No. 4 sheet in which the important element cobalt (Co) is not included, doesn't show satisfactory result, that is, it shows under 60 kg/mm² T.S., as well as plating characteristics of which the outer appearance was evaluated as B-class.

No. 1-No. 3 test sheets satisfying relations of the formula o,6≦Si+0.78 Al (%)≦1.2, and including 0.3-0.8% cobalt, show heat treatment conditions within those of the present invention. In these test pieces, part rate of the retained austenite shows more than four(4)%. These test sheets also show excellent mechanical properties like T.S. more than 60 kg/mm² elongation more than 28%. Further, these test pieces show the steel sheet of the present invention, excellent in plated surface properties evaluated as class A than the steel sheet with non-cobalt addition.

However, even in No. 1 to No. 3 test pieces, volume ratio of the retained austenite shows 2% less, and elongation 28% less, It means that the characteristics of the mechanical properties are confirmed as those deteriorated.

No. 5 and No. 6 are the comparative test sheets, show that Si+0.78A1(%)>1.2, and excellent value in parts of the retained austenite, and elongation ratio, but lower tensile strength(T.S.). In these cases, the fact that non-addition of cobalt and large value of the Si+0.78 Al(%), deterioration of plating characteristic, can be confirmed.

In the cases of No. 7 and No. 8, even the cobalt also is not added, it's plating characteristic is shown as excellent. However, it can be confirmed that no formation of retained austenite caused by low value of Si+0.78 Al(%), results poor elongation less than 28%.

In the case No. 9 of the comparative test sheet, strength and elongation show excellent value, however, the value of Si+0.78A1(%) was in excess of 1.2, and outer appearance of the plating was evaluated as C-class caused by non-addition of cobalt (Co).

As stated the above, steel slab of the present invention, comprising chemical compositions of C:0.05-0.20wt. %, Si:0.05-0.35 wt. %, Mn:1.0-2.5wt. %, Al:0.01-1.5 wt. %, P:not more than 0.02wt. %, ° Co: 0.3-0.8wt. %, and that relations between the Si and Al, satisfy the formula 0.6≦Si+0.78 Al(%)≦1.2, remained are Fe and inevitable impurities, is subject to hot-rolled, coiled at 500-700° C., then, cold-rolled with reduction rate of 30-80%, thereafter recrystallization annealing heat treated in the range of 740-880° C. for 1-5 min., and then, cooled to 300-580° C. with cooling rate 2-100° C./sec., and reserved at this temperature range for 10 min. and less, and zinc-plated in the Zn plating bath, and then, alloying heat treated at the temperature range of 460-600° C., for 2 min. and less., and finally cooled, may surely effects for obtaining controlled 5-20% of Fe(%) in the plated layer, satisfying 2-20% volume ratio of the retained austenite in the steel structure of hot-dip zinc plated steel sheet having transformation induced plasticity satisfying more than 60 kg/mm² of tensile strength, and elongation more than 28%.

TABLE 1

| | Chemical composition (wt. %) | | | | | | | |
|---|---|---|---|---|---|---|---|---|
| | | | | | | | Value | |
| | | | | | | | of | |
| Test | | | | | | | formula | |
| No. | C | Si | Mn | Al | P | Co | (1) | Remarks |
| 1 | 0.136 | 0.285 | 1.470 | 0.858 | 0.002 | 0.296 | 0.95 | Invention |
| 2 | 0.145 | 0.300 | 1.540 | 0.880 | 0.002 | 0.507 | 0.99 | Invention |
| 3 | 0.135 | 0.271 | 1.410 | 0.850 | 0.003 | 0.728 | 0.93 | Invention |
| 4 | 0.126 | 0.269 | 1.420 | 0.804 | 0.003 | 0.000 | 0.90 | Comparative |
| 5 | 0.097 | 0.493 | 1.485 | 1.054 | 0.002 | 0.000 | 1.32 | Comparative |
| 6 | 0.089 | 0.500 | 1.512 | 1.589 | 0.003 | 0.000 | 1.74 | Comparative |
| 7 | 0.092 | 0.223 | 1.480 | 0.040 | 0.026 | 0.000 | 0.25 | Comparative |
| 8 | 0.068 | 0.040 | 2.245 | 0.066 | 0.010 | 0.000 | 0.09 | Comparative |
| 9 | 0.104 | 1.284 | 1.481 | 0.042 | 0.019 | 0.000 | 1.32 | Comparative |

(Note)
Comparative = Comparative Example

TABLE 2

| class | Evaluation Standard of outer appearance of plated sheet |
|---|---|
| A | Appearance defect of surface, is not found |
| B | Local non-plated defects found:un-plated area ratio: less than 1% |
| C | Un-plated area ratio 1˜10% |
| D | Un-plated area ratio: in excess of 10% |

TABLE 3

| | | | | | | | Volume | | | | | |
|---|---|---|---|---|---|---|---|---|---|---|---|---|
| | Process conditions | | | | | | ratio of | Outer | Fe % | Mech. property | | |
| | | | | | Alloying | Alloying | retained | appearance | in the | T.S. | | |
| Test | Reduction | Annealing | Annealing | Cooling rate | Temp. | Work | austenite | of plated | plated | (kg/ | Elong. | |
| No. | ratio (%) | temp (° C.) | time (sec) | (° C./sec) | (° C.) | time (sec) | ( %) | surface | layer | mm²) | (%) | Remarks |
| 1 | 75 | 820 | 111 | 15 | 520 | 25 | 7.1 | A | 11.5 | 60.4 | 30.8 | Invention |
| 1 | 75 | 840 | 111 | 15 | 520 | 25 | 7.8 | A | 12.0 | 60.2 | 33.1 | Invention |
| 1 | 75 | 800 | 111 | 15 | 480 | 25 | 9.1 | A | 9.8 | 60.5 | 35.6 | Invention |
| 1 | 75 | 800 | 111 | 15 | 500 | 25 | 8.2 | A | 10.5 | 61.4 | 33.7 | Invention |
| 1 | 75 | 800 | 111 | 15 | 650 | 25 | 0.5 | A | 28.0 | 60.1 | 25.6 | Compara. |
| 2 | 75 | 800 | 111 | 15 | 520 | 25 | 12.0 | A | 12.4 | 62.6 | 32.1 | Invention |
| 2 | 75 | 820 | 111 | 15 | 520 | 25 | 10.2 | A | 13.5 | 63.4 | 30.5 | Invention |
| 2 | 75 | 840 | 111 | 15 | 520 | 25 | 10.5 | A | 12.2 | 63.4 | 31.5 | Invention |
| 2 | 75 | 860 | 111 | 15 | 520 | 25 | 11.3 | A | 11.7 | 62.2 | 33.7 | Invention |
| 2 | 75 | 800 | 111 | 15 | 480 | 25 | 14.0 | A | 8.9 | 62.5 | 36.1 | Invention |
| 2 | 75 | 800 | 111 | 15 | 500 | 25 | 12.5 | A | 10.6 | 63.7 | 33.6 | Invention |
| 2 | 75 | 800 | 111 | 15 | 650 | 25 | 1.3 | A | 26.5 | 61.2 | 27.8 | Compara. |
| 3 | 75 | 820 | 111 | 15 | 520 | 25 | 4.1 | A | 11.4 | 60.6 | 31.1 | Invention |
| 3 | 75 | 840 | 111 | 15 | 520 | 25 | 5.0 | A | 10.6 | 60.1 | 31.1 | Invention |
| 3 | 75 | 800 | 111 | 15 | 480 | 25 | 8.7 | A | 13.4 | 60.4 | 37.5 | Invention |
| 3 | 75 | 800 | 111 | 15 | 500 | 25 | 4.0 | A | 10.8 | 60.1 | 30.0 | Invention |
| 3 | 75 | 800 | 111 | 15 | 650 | 25 | 0.8 | A | 25.4 | 60.0 | 27.1 | Compara. |
| | 75 | 800 | 111 | 15 | 520 | 25 | 5.0 | B | 15.3 | 57.6 | 32.8 | Compara. |
| 4 | 75 | 820 | 111 | 15 | 520 | 25 | 4.5 | B | 14.2 | 57.6 | 31.3 | Compara. |
| 4 | 75 | 840 | 111 | 15 | 520 | 25 | 5.4 | B | 15.9 | 57.7 | 32.8 | Compara. |
| 4 | 75 | 860 | 111 | 15 | 520 | 25 | 3.9 | B | 13.5 | 57.1 | 31.1 | Compara. |
| 5 | 75 | 800 | 111 | 15 | 520 | 25 | 4.5 | C | 13.4 | 58.5 | 31.3 | Compara. |
| 5 | 75 | 820 | 111 | 15 | 520 | 25 | 5.4 | C | 14.6 | 57.1 | 33.4 | Compara. |
| 5 | 75 | 840 | 111 | 15 | 520 | 25 | 3.9 | C | 12.9 | 58.0 | 31.4 | Compara. |
| 5 | 75 | 860 | 111 | 15 | 520 | 25 | 4.5 | C | 14.0 | 56.2 | 32.7 | Compara. |
| 6 | 75 | 800 | 111 | 15 | 520 | 25 | 3.9 | D | 13.4 | 59.9 | 32.8 | Compara. |
| 6 | 75 | 820 | 111 | 15 | 520 | 25 | 4.2 | D | 12.8 | 58.5 | 32.9 | Compara. |
| 6 | 75 | 840 | 111 | 15 | 520 | 25 | 3.8 | D | 15.6 | 59.4 | 31.6 | Compara. |
| 6 | 75 | 860 | 111 | 15 | 520 | 25 | 4.9 | D | 14.2 | 59.9 | 33.0 | Compara. |
| 7 | 50 | 800 | 111 | 15 | 520 | 25 | 0 | A | 12.1 | 61.2 | 27.0 | Compara. |
| 8 | 50 | 800 | 111 | 15 | 520 | 25 | 0 | A | 21 | 64.5 | 26.4 | Compara. |
| 8 | 50 | 820 | 111 | 15 | 520 | 25 | 0 | A | 25 | 63.5 | 25.6 | Compara. |
| 8 | 50 | 840 | 111 | 15 | 520 | 25 | 0 | A | 22 | 63.3 | 24.9 | Compara. |
| 9 | 50 | 800 | 111 | 15 | 520 | 25 | 2.6 | C | 5.6 | 68.9 | 30.4 | Compara. |
| 9 | 50 | 820 | 111 | 15 | 520 | 25 | 2.3 | C | 6.4 | 69.2 | 29.7 | Compara. |
| 9 | 50 | 840 | 111 | 15 | 520 | 25 | 2.9 | C | 4.5 | 68.9 | 29.6 | Compara. |
| 9 | 50 | 860 | 111 | 15 | 520 | 25 | 4.6 | C | 5.0 | 68.2 | 29.3 | Compara. |

(Note)
Compara. = Comparative Example

1. A hot-dip galvanized steel sheet having transformation induced plasticity, comprising:

| | |
|---|---|
| C: | 0.05-0.20 wt. %, |
| Si: | 0.05-0.35 wt. %, |
| Mn: | 1.0-2.5 wt. %, |
| Al: | 0.01-1.5 wt. %, |
| P: | not more than 0.02 wt. %, |
| Co: | 0.1-0.8 wt. %, |

remained are Fe and inevitable impurities, and, satisfying relations between the above Si and Al, as
0.6≦Si+0.78 Al(%)≦1.2 (1)
for producing the above said hot-dip galvanized steel sheet more than 60 kg/mm² of tensile strength (T.S.), and more than 28% of elongation.

2. A hot-dip galvanized steel sheet having transformation induced plasticity, according to the claim 1,
wherein, the galvanized steel sheet is produced by way of:
hot-rolling the steel slab comprising the above chemical compositions, of which finished rolling temperature should be higher than A3 transformation temperature, and descaling, and coiling the steel sheet at the temperature of 500° C. to 700° C.;
recrystallization annealing treatment at the temperature range of 740° C. to 880° C. for one (1) to five (5) minutes;
cooling it to the temperature of 300° C. to 580° C. with cooling rate of 2-100° C./sec. and heat preserving it at this temperature range for not more than 10 min.;
zinc plating in galvanizing bath and finally being cooled, and finished,
for producing the above said hot-dip galvanized steel sheet more than 60 kg/mm² of tensile strength (T.S.), and more than 28% of elongation.

3. A hot-dip galvanized steel sheet having transformation induced plasticity, according to claim 2,
wherein, the galvanized steel sheet is produced by way of
hot-rolling of the steel slab comprising the above said chemical compositions, and coiling the hot-rolled steel sheet at the range of 500° C. to 700° C.;
cold-rolling of the above coiled steel sheet in an amount of 30 to 80% area reduction rate;
recrystallization annealing treatment at 740° C. to 880° C. for one (1) to five (5) minutes.;
cooling the above annealing heat treated steel to temperature of 300° C. to 580° C. at the cooling rate of 2° C. to 100° C./sec., preserving the steel sheet at the above said temperature range for not more than 10 minutes;
zinc plating and alloying heat treating at the temperature range of 460° C. to 600° C., for two(2) min. or less, then, finally being cooled,
for producing the above said hot-dip galvanized steel sheet more than 60kg/mm² of tensile strength (T.S.) and more than 28% of elongation.
